(19) United States
(12) Patent Application Publication
(10) Pub. No.: US 2008/0247848 A1
(43) Pub. Date: Oct. 9, 2008

(54) Method and System for Operating a Shelf in a Commissioning System

(76) Inventor: Karl Freudelsperger, Hart bei Graz (AT)

Correspondence Address: MCGLEW & TUTTLE, PC, P.O. BOX 9227, SCARBOROUGH STATION, SCARBOROUGH, NY, 10510-9227, US

(21) Appl. No.: 10/597,430

(22) PCT Filed: Feb. 14, 2005
(86) PCT No.: PCT/EP05/01467

§ 371 Date: Jul. 25, 2006

(30) Foreign Application Priority Data
Feb. 16, 2004 (DE) 10 2004 007 412.7

(51) Int. Cl. B65G 1/02

(52) U.S. Cl. 414/277; 414/807

(57) ABSTRACT

The invention relates to a method and a system for operating a shelf in a commissioning system, comprising a shelf (1) and a storage and retrieval unit (2) associated therewith for storing and retrieving containers (3), trays or the like in or from the shelf. A height range of the shelf (1) comprising a plurality of superimposed shelf planes (a, b, c, d) can be operated as an autonomous shelf unit (I, II, III or IV) via at least one mechanically coupled longitudinally adjustable storage and retrieval unit (2) and at least two autonomous shelf units are provided for a single shelf. The invention is characterized in that the storage and retrieval unit (2) is displaced from a shelf unit (I; II; III or IV) to another shelf unit (II, III, IV or I, III, IV or I, II, IV or I, II, III) of the same shelf (1) or of another shelf (1′), preferably to another shelf unit which is not yet provided with a storage and retrieval unit of the same kind.

### CROSS REFERENCE TO RELATED APPLICATIONS

This application is a United States National Phase application of International Application PCT/EP2005/001467 filed Feb. 14, 2005 and claims the benefit of priority under 35 U.S.C. §119 of German Application DE 10 2004 007 412.7 filed Feb. 16, 2004, the entire contents of which are incorporated herein by reference.

### FIELD OF THE INVENTION

The present invention pertains to a method and a system for operating a shelf in a commissioning system, with a shelf and an associated storage and retrieval unit for retrieving and introducing containers, trays or the like from or into the shelf, wherein a height area of the shelf, having a plurality of shelf levels arranged one on top of another, can be operated as an independent shelf unit by means of at least one mechanically coupled, longitudinally adjustable storage and retrieval unit, and at least two independent shelf units are provided in a single shelf

### BACKGROUND OF THE INVENTION

When “containers” will be referred to below, these shall not be defined restrictively; the present invention rather also comprises systems in which other transport units, for example, trays or pallets are used in order to store and to transport the commissioned goods, or the preferably large commissioned goods without containers themselves.

According to a known state of the art according to DE 101 36 354.0, a height area of the shelf, comprising a plurality of shelf levels arranged one on top of another, is operated by means of a mechanically coupled, height-adjustable and longitudinally adjustable, separate storage and retrieval unit of its own. Containers, trays or the like, which are taken over by the storage and retrieval unit for storage or are released for retrieval from storage and are delivered by means of at least one elevator and/or a conveying connection from or to a conveying system or processing site that is external in respect to the shelf, are stored here intermediately in each height area of the shelf designed as an independent and closed shelf unit in a buffer zone located at the same level as an interface to the outside. The buffer zone stores the products until they can be taken over by the elevator system. A highly flexible interface with the external material handling system of the shelf and especially high commissioning output can be established as a result.

However, it is disadvantageous that because of the use of a larger number of storage and retrieval units, which are nevertheless heavy and complicated, and which ultimately ensure a high commissioning output, high costs arise for setting up a shelf In addition, great shelf heights are possible only conditionally in manufacturing the shelves because of the static overall weight with slender design of the shelf Great overall heights are possible only conditionally already because of the action of the global static and dynamic forces of all storage and retrieval units.

### SUMMARY OF THE INVENTION

The basic object of the present invention is to make the prior-art method and system mentioned in the introduction markedly simpler while essentially maintaining or even increasing the efficiency.

The essence of the method and system according to the present invention for operating a shelf is that the mechanically coupled, longitudinally adjustable storage and retrieval unit, which operates a height area of the shelf, which has a plurality of shelf levels arranged one on top of another, as an independent shelf unit, is transferred or can be transported from one shelf unit into another shelf unit of the same shelf or of another shelf.

The efficiency of the prior-art method is thus basically preserved, because all storage and retrieval units—fewer units than according to the state of the art—are used precisely there and in the shelf units where and in which they are actually needed. If a shelf unit, which precisely has too few units in use there, requires an additional unit because of the increased turnover of goods to be commissioned there, an additional storage and retrieval unit is transported thereto and is additionally used there according to the present invention.

In particular, a storage and retrieval unit is transferred into another shelf unit when no storage and retrieval unit of the same kind is still present there and commissioning is precisely to be performed there.

The storage and retrieval unit, which is preferably connected to the shelf via horizontal rails and is guided longitudinally, is expediently transported vertically from one shelf unit into another shelf unit by means of a vertical elevator, preferably at a longitudinal end of the shelf.

However, in an advantageous variant of the present invention, the storage and retrieval unit may also be displaced horizontally from one shelf to another shelf, preferably in a height position that is located at a spaced location from the bottom of the shelf on a horizontal path between the shelves or transferred horizontally together with the horizontal path, in which case the horizontal path can expediently also be displaced vertically and can be positioned in any height position of a shelf unit, preferably aligned with the horizontal rails of the shelves, which rails are located there.

A storage and retrieval unit that is vertically extensible may optionally be brought into a compact, flat, withdrawn position before transfer.

The storage and retrieval unit is equipped with containers or trays, which are transferred together with the storage and retrieval unit and are introduced into the other shelf unit or, conversely, released, after transfer of the storage and retrieval unit, either before transfer, or, in an alternative embodiment, they are equipped with containers or trays in the other shelf unit only after transfer, and the containers or trays to be introduced are transported to the other shelf unit by means of separate conveying means, preferably by means of a transport elevator, on the other longitudinal end of the shelf facing away from the vertical elevator only separately and are taken over or, conversely, released by the storage and retrieval unit for introduction into the other shelf unit only then in the other shelf unit.

Consequently, it is possible by means of an elevator system, arranged preferably at the end of the aisle, to transfer a storage and retrieval unit, which can operate a plurality of individual shelf levels (individual aisles) arranged one on top of another, from a horizontal aisle or shelf unit into another horizontal aisle (other shelf unit), preferably to transport it vertically, when needed. The storage and retrieval units can thus have a comparatively small vertical mast height, and great overall height of a shelf can likewise be embodied in a warehouse in a building. In particular, cost reduction is advantageously achieved due to the throughput-dependent number of storage and retrieval units compared to the number of individual levels (i.e., the aisles arranged one on top of another in the shelf system, which are operated with one storage and retrieval unit). Great overall height in the shelf construction is possible because the overall dynamic and static forces are minimized due to the minimization of the storage and retrieval units, which are moved one on top of another. Furthermore, it is also possible to operate the storage and retrieval units with lower acceleration and velocity beginning from a certain level or a certain height of a shelf unit because of the dynamic loads on the shelf Transfer is possible both with products and without products on the load receiving means of the storage and retrieval unit, which is adjustable in height within a shelf unit over the entire height of the shelf unit, preferably along a vertical mast.

The innovation advantageously consists of the possibility of optimally coordinating the aspects of economy in respect to throughput and costs with the needs of a human user or a customer of the manufacturer of such storage and retrieval units.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 shows a schematic perspective view of a storage and retrieval unit according to the present invention with two shelves in a commissioning system with an aisle located in between, in which storage and retrieval units are operated at different shelf heights,

FIG. 2 shows an enlarged detail of the storage and retrieval system with a storage and retrieval unit according to FIG. 1 in the area of a vertical elevator,

FIGS. 3, 4, 5 and 6 show the storage and retrieval system according to FIG. 1 during the transfer of a storage and retrieval unit from one shelf unit into another shelf unit located directly above it by means of the vertical elevator,

FIGS. 7, 8 and 9 show a storage and retrieval system with a storage and retrieval unit according to FIG. 1 during horizontal transfer between two shelves at the height of a shelf unit, and

FIGS. 10 through 15 show the storage and retrieval system according to the present invention with another storage and retrieval unit in views similar to those in FIGS. 1 through 6.

### DESCRIPTION OF THE PREFERRED EMBODIMENTS

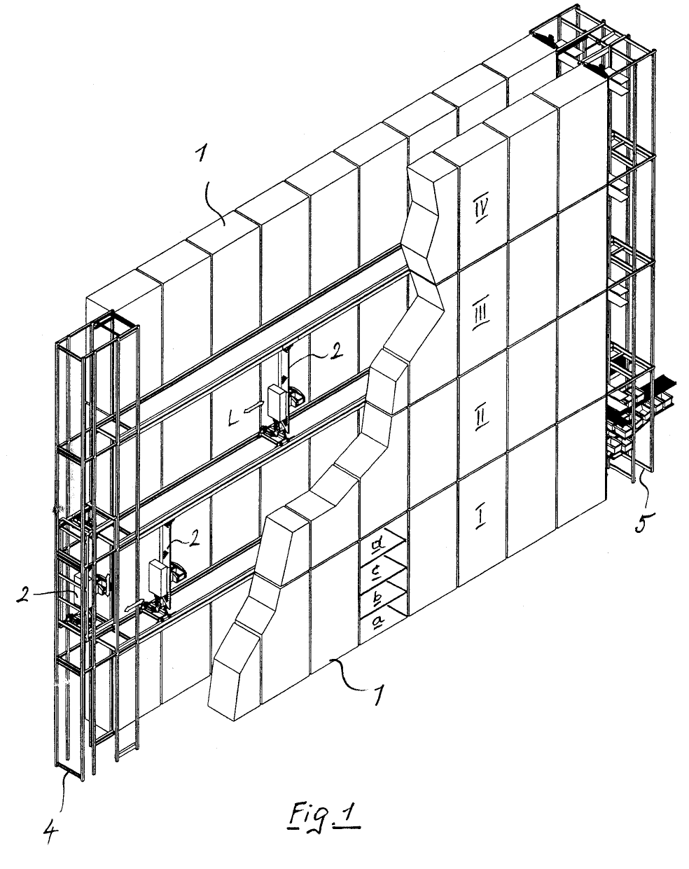

Referring to the drawings in particular, FIG. 1 shows a storage and retrieval system for operating a shelf in a commissioning system comprises a shelf 1 and storage and retrieval units 2 which are arranged in the shelf and are associated with the shelf, for retrieving and introducing containers 3, trays or the like from or into the shelf.

The shelf 1 has a plurality of independent shelf units I, II, III, IV, which are arranged one on top of another, each shelf unit being divided into a plurality of shelf levels a, b, c, d arranged one on top of another. Connected horizontal rails 10, which extend along the shelf front on the bottom side and on the ceiling side and on which storage and retrieval units 2 can be displaced in a nontilting manner, i.e., in a longitudinally and laterally guided manner, horizontally in the longitudinal direction L, are located in each shelf unit I, II, III, IV. The storage and retrieval units 2 are thus mechanically coupled with the shelf 1 and, in particular, they are longitudinally adjustable not only along the shelf front, but every individual storage and retrieval unit is also adjustable in height in respect to its load receiving means (7) in order to make it possible to reach and operate the shelf levels a, b, c, d located at different levels within a shelf unit I, II, III or IV.

In particular, each storage and retrieval unit 2 can be transferred from a shelf unit I; II; III or IV into another shelf unit II, III, IV or I, III, IV or I, II, IV or I, II, III of the same shelf 1 or of another shelf 1′, i.e., it can be displaced or shifted horizontally and vertically, in practice especially when no storage and retrieval unit 2 is precisely present in the other shelf unit that is to be commissioned.

The storage and retrieval unit 2 is transported vertically from one shelf unit into another shelf unit by means of a vertical elevator 4. The vertical elevator 4 is located at the longitudinal end of the shelf 1 that is the left-hand end according to FIG. 4. A transport elevator 5, which will be discussed later, is located at the other longitudinal end of the shelf 1.

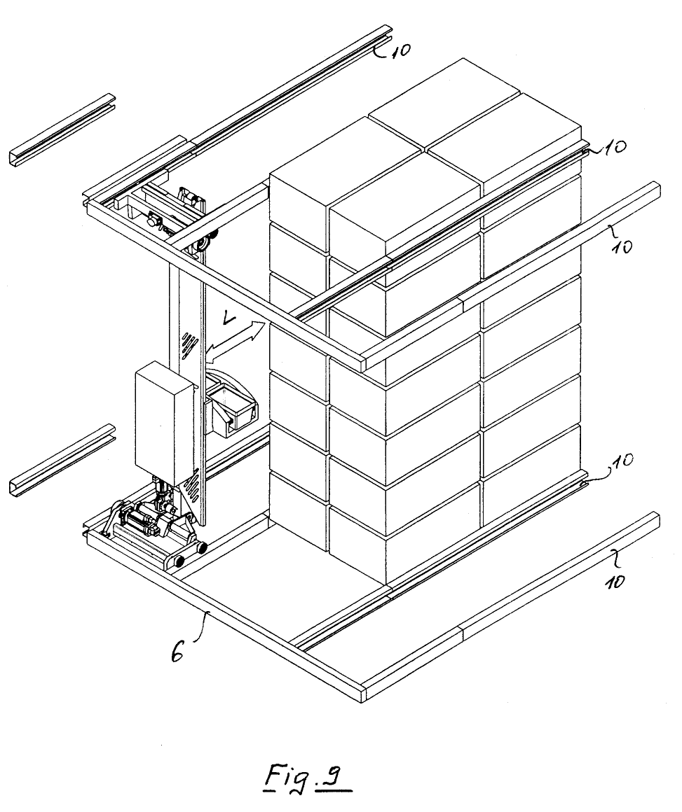

As can be determined from FIGS. 7 through 9, the storage and retrieval unit 2 can also be displaced or shifted, in a preferred variant, horizontally in the transverse direction Q relative to the longitudinal extension of the horizontal rails 10 from one shelf 1 to another shelf 1′, preferably in a height position h located at a spaced location from the bottom of the shelf on a horizontal path 6 between the shelves 1, 1′.

The horizontal path 6 may optionally also be displaced vertically.

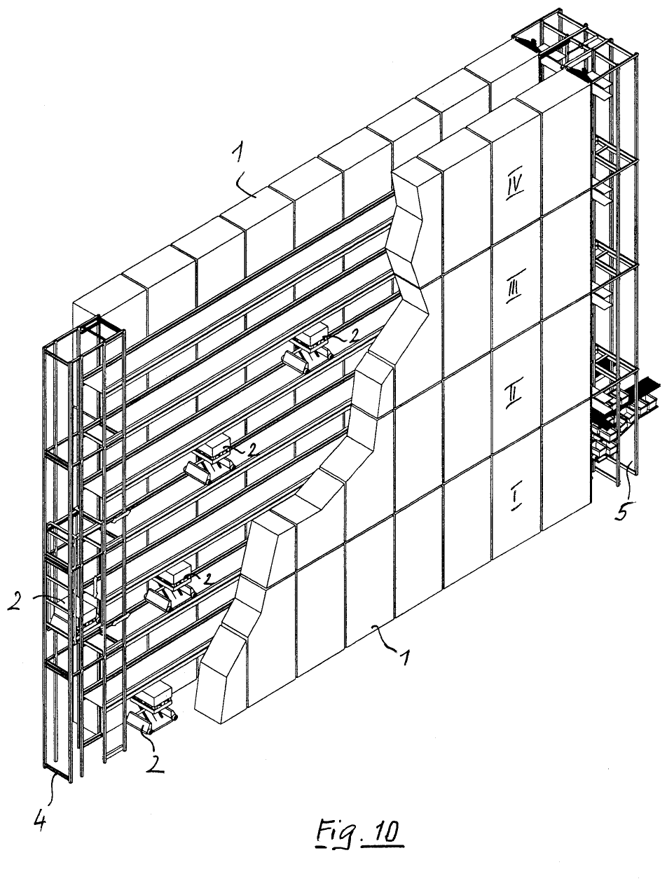

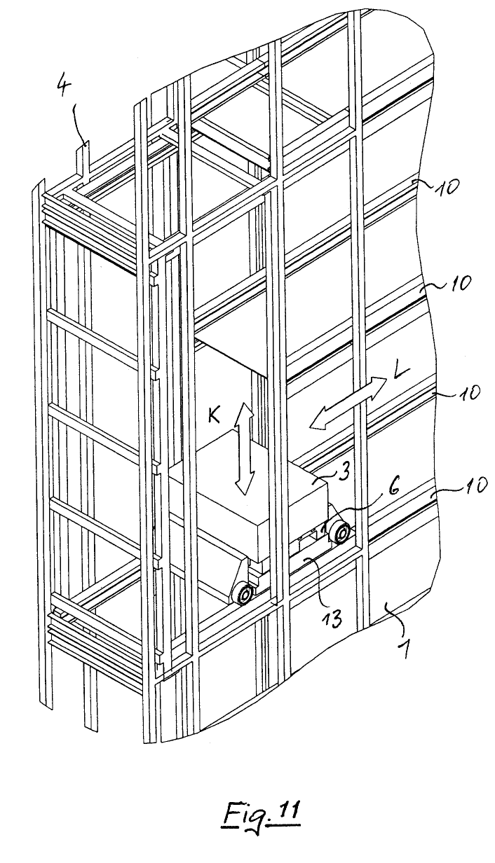

A storage and retrieval unit 2, which can be vertically extended, may optionally be brought into a compact, flat, withdrawn position K before transfer, as this can be determined from FIGS. 10 through 15.

Before transfer, the storage and retrieval unit 2 may be equipped with containers 3 or trays, which are transferred together with the storage and retrieval unit and are introduced into the other shelf unit after the transfer of the storage and retrieval unit or are, conversely, released.

However, as an alternative, the storage and retrieval unit 2 may also be equipped with containers 3 or trays in the other shelf unit only after transfer, in which case the containers 3 or trays to be introduced are transported only separately to the other shelf unit by means of separate conveying means, namely, with the use of the above-mentioned transport elevator 5, and they are taken over or, conversely, released, only thereafter in the other shelf unit by the storage and retrieval unit 2 for introduction into the other shelf unit.

Consequently, the storage and retrieval system according to the present invention is characterized especially by a transferring device with a vertical elevator 4 for transferring the storage and retrieval unit 2 from one shelf unit I, II, III or IV into another shelf unit II, III, IV or I, III, IV or I, II, IV or I, II, III of the same shelf 1 or of another shelf 1′, the said vertical elevator 4 being arranged in the area of the longitudinal end of shelf 1.

The vertical elevator 4 has holding and fixing means for a storage and retrieval unit 2, which is to be received and to be vertically displaced. In particular, the vertical elevator 4 and/or each longitudinal end of each shelf unit I, II, III, IV facing the vertical elevator has locking means, which block a shelf unit 2 in relation to the vertical elevator 4 for the reliable reception of a storage and retrieval unit in the shelf unit when the vertical elevator is being operated in another height position.

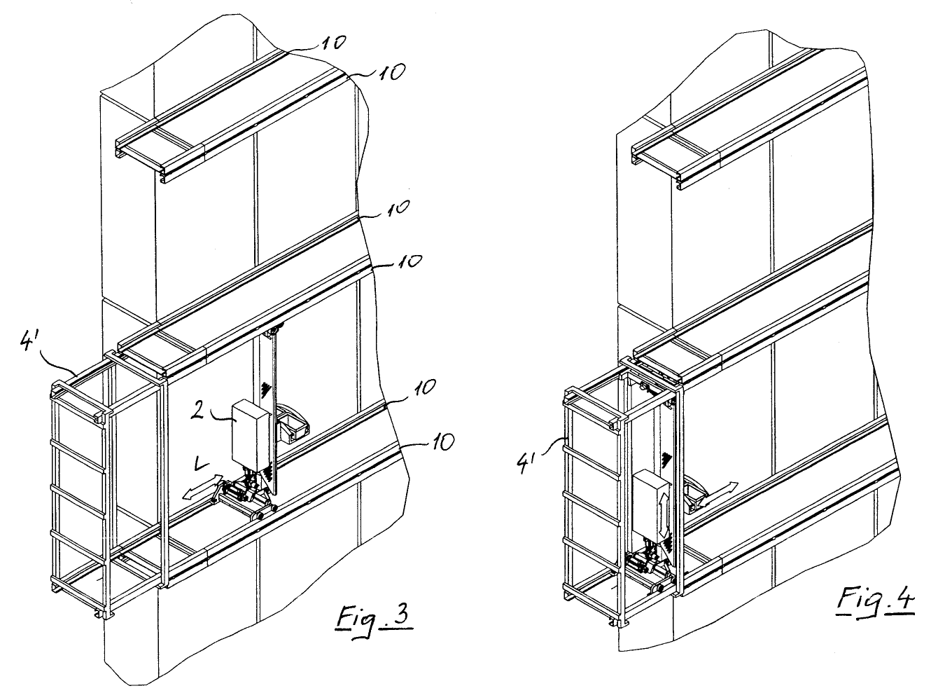

The vertical elevator 4 extends over the entire height of the shelf 1 and comprises an elevator cage 4′ similar to a passenger elevator cabin for receiving a storage and retrieval unit 2, which can be vertically displaced between two shelf units I, II, III, IV located one on top of another and can be positioned at the height of the selected shelf unit in relation to the horizontal rails 10 located there, exactly aligned with the horizontal rails 10 present there, at a short horizontal distance, as this can be seen in FIGS. 3 through 6.

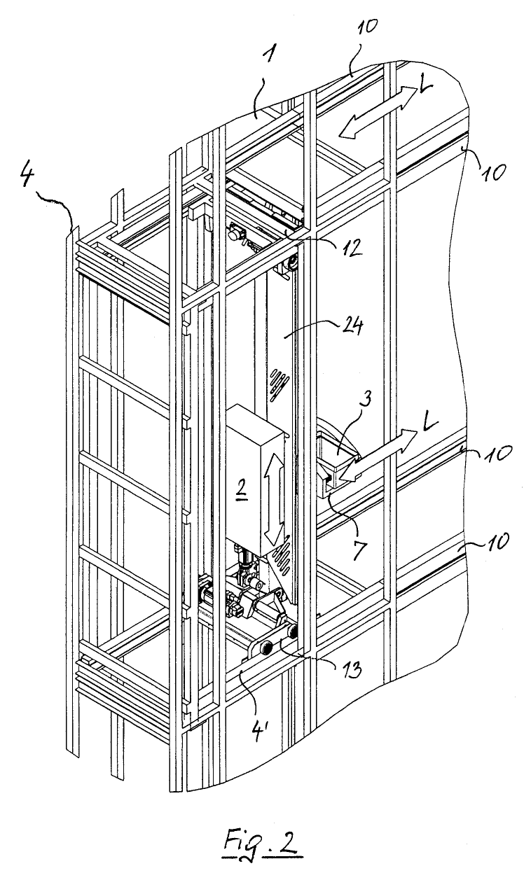

The storage and retrieval unit 2 according to FIGS. 1 through 9 has lower and upper chassis 12, 13, which are displaceable in fixed horizontal rails 10 along a shelf front in a nontilting manner at the levels of the shelf units I, II, III, IV. The storage and retrieval unit 2 has a vertical mast 24 between the upper and lower chassis 12, 13, a height-adjustable load receiving means 7 for containers 3 or trays being provided along the vertical mast 24. The vertical mast may have an articulated joint 20, which makes possible the deflection of the mast in the direction of longitudinal displacement L, the articulated joint 20 being provided in the area of the upper chassis 12 of the storage and retrieval unit 2. The vertical mast 24 extends over the height of a shelf unit I, II, III, IV.

In an alternative embodiment, a storage and retrieval unit 2, which is vertically extensible and is provided with a vertically displaceable lifting table 6, which is withdrawn into a compact, flat position K before transfer and has only a lower chassis 13, is provided according to FIGS. 10 through 15. The compact withdrawn position makes possible a simple displacement or transfer in a height-adjustable lifting cage 4′ in the vertical elevator 4. The top-side horizontal rails 10 of the first embodiment variant are unnecessary in this embodiment variant. The transfer from one shelf unit into another shelf unit otherwise takes place according to FIGS. 12 through 15 as the transfer of a storage and retrieval unit 2 of the first embodiment variant according to FIGS. 3 through 6.

Consequently, the vertical elevator 4 is preferably arranged at the end of the aisle, which connects all aisle levels or some of the aisle levels with one another such that it is possible to transfer the storage and retrieval units operating in the aisle from one aisle level into another one. All transfer motions are carried out by means of drives located at the storage and retrieval unit operating in the aisle. All drives or some drives may optionally also be provided on the shelf side. The pulling or push-over motion of a storage and retrieval unit may also be carried out by means of actuators, which are fastened to the elevator system.

The operation of transferring a storage and retrieval unit 2 according to the two embodiment variants takes place specifically as follows.

According to FIGS. 3 and 12, the storage and retrieval units move in the particular aisle level or shelf unit in the longitudinal direction L of the shelf For transfer into a new aisle level or into another shelf unit, the storage and retrieval unit moves into the corresponding end area of the aisle level, to the left in the exemplary embodiments.

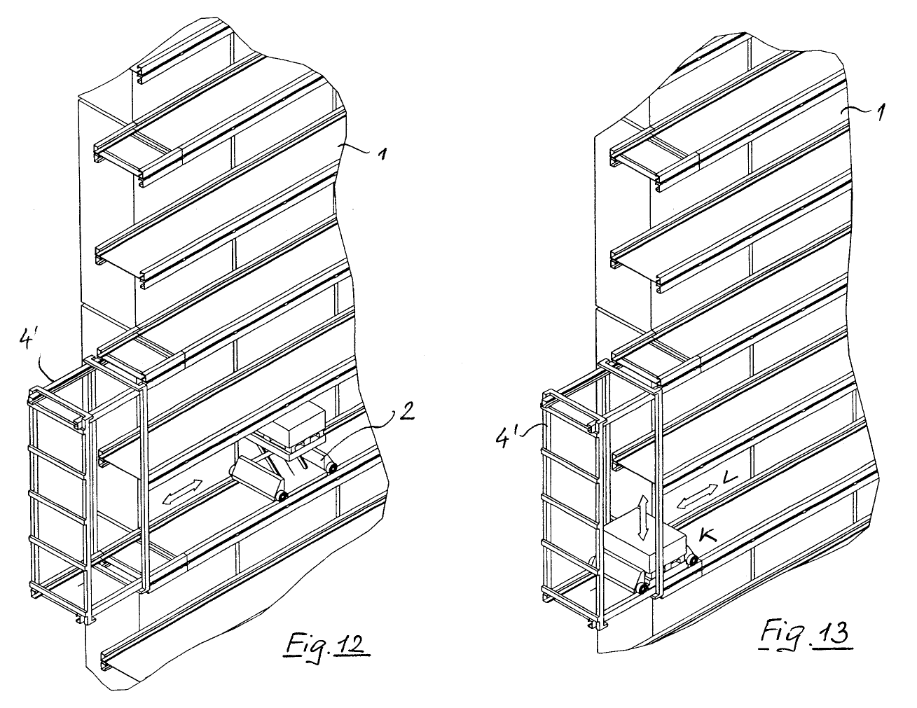

After the vertical cage 4′ has become completely positioned in the correct level or shelf unit—this operation may, of course, also have been carried out before the storage and retrieval unit 2 reaches the end position—the safety device at the end of the aisle is unlocked or deactivated, and the storage and retrieval unit can move over to the transfer unit according to FIGS. 4 and 13. After moving over, the storage and retrieval unit is locked at the vertical elevator 4 against moving out of the elevator cage 4′.

After the storage and retrieval unit 2 has become completely positioned into the elevator cage 4′ onto the extension rails present there, which are exactly aligned with the horizontal rails 10 of the corresponding aisle level or the corresponding shelf unit, the elevator cage 4′ moves, according to FIGS. 5 and 14, together with the secured storage and retrieval unit 2 received, vertically in the vertical elevator 4 into the intended new aisle level.

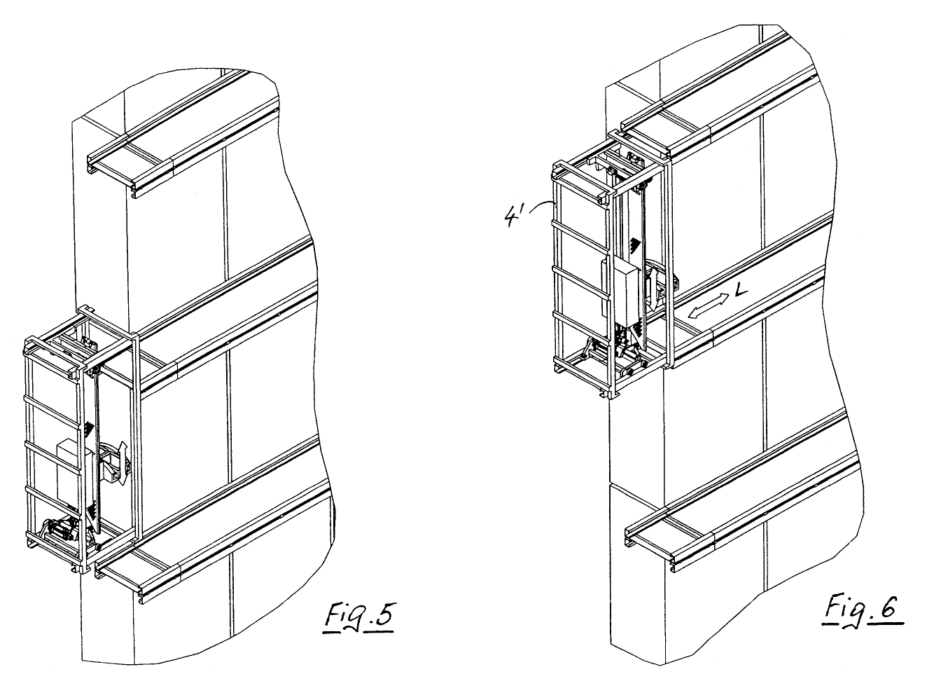

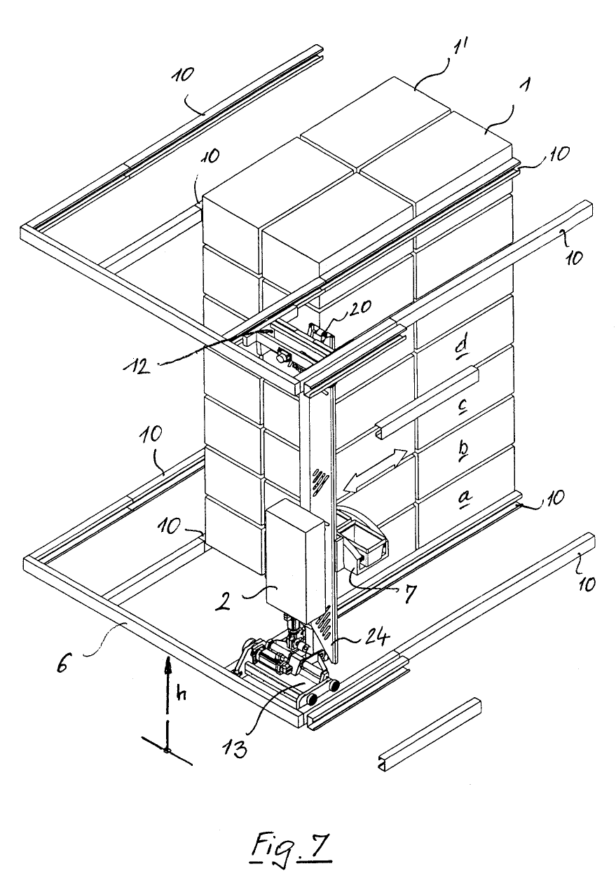

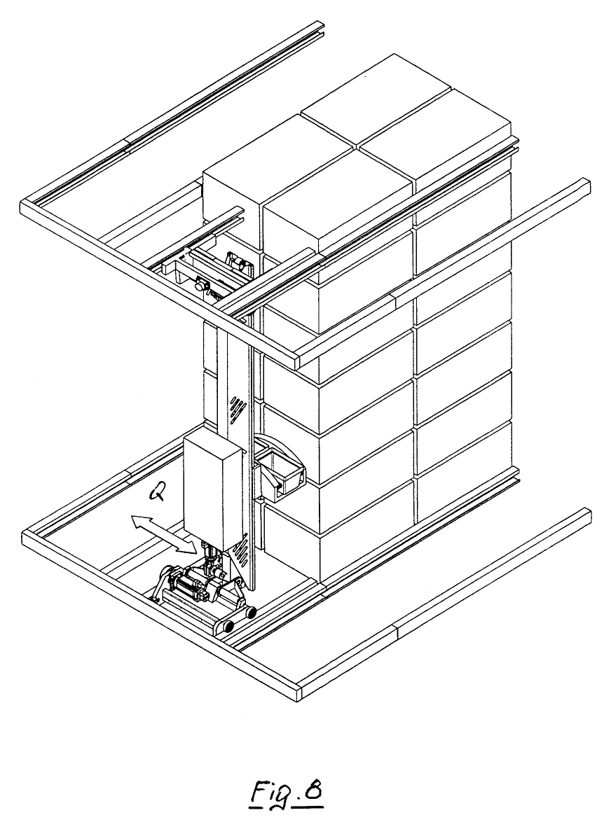

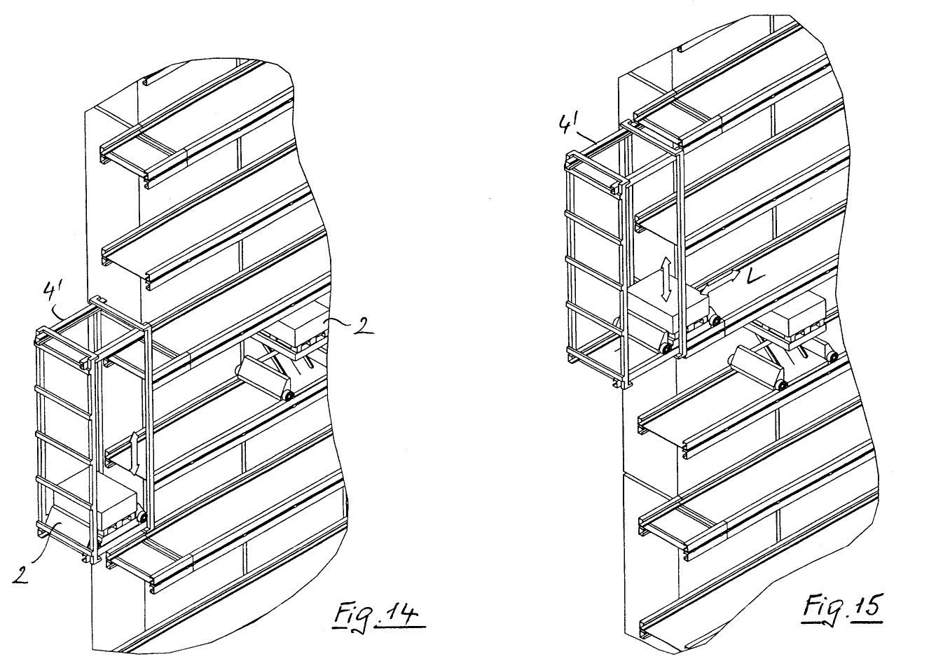

After the target position has been reached according to FIGS. 6 and 15, with the extension rails of the elevator cage 4′ being exactly aligned with the horizontal rails 10 of the new level or shelf unit, which said rails are located at a short distance, the storage and retrieval unit 2 moves into the new aisle level. The safety device for the aisle end is then again activated, and the storage and retrieval unit can assume operation in the new level or in the new shelf unit.

The most essential advantage of the present invention is that the aspects of economy in terms of throughput and costs can be optimally coordinated with the needs of a human user or a customer of the manufacturer of such storage and retrieval systems.

This shall be globally explained on the basis of an example.

A shelf of a height of approx. 30 m comprises 7 levels (shelf units) with 8 container sites (shelf levels) each one on top of another. Thus, there are 56 container positions one on top of another, which are divided into 7 level or aisle sections, preferably of equal height. These seven levels are now operated by, e.g., four storage and retrieval units. Each of these four storage and retrieval units operates the eight container sites located one on top of another in the individual level (aisle). To make it possible to operate e total number of levels with these four storage and retrieval units, the storage and retrieval units are transferred by means of an elevator system. This elevator system is arranged preferably at the end of the aisle, to the right and/or left, but it may also be provided in the middle of the shelf or in the middle of the aisle. As can be seen, the four storage and retrieval units according to the present invention can consequently produce an intended commissioning output that is accomplished by seven storage and retrieval units (one storage and retrieval unit in each level) according to the state of the art, because it may be assumed that not all storage and retrieval units are usually used simultaneously for commissioning. By saving three storage and retrieval units, the shelf can consequently be manufactured, on the whole, with a correspondingly lower weight and at a correspondingly lower cost and/or a great shelf height can be set up.

While specific embodiments of the invention have been shown and described in detail to illustrate the application of the principles of the invention, it will be understood that the invention may be embodied otherwise without departing from such principles.

1. A method for operating a shelf comprising:
providing one or more shelves and one or more mechanically coupled and longitudinally adjustable associated storage and retrieval units for retrieving and introducing containers, trays or the like from or into one or more shelves;
providing height areas defined between one shelf and another shelf having a plurality of shelf levels, said shelf levels being arranged one on top of another and operating as independent shelf units and vertically transferring said storage and retrieval units from one or more independent shelf units into one or more other independent shelf units of the same shelf or of another shelf.

2. A method in accordance with claim 1, wherein said storage and retrieval unit is transferred into another shelf unit, which does not yet have a storage and retrieval unit of the same type.

3. A method in accordance with claim 1, wherein said storage and retrieval unit is transported vertically by means of a vertical elevator from one said shelf unit into another said shelf unit.

4. A method in accordance with claim 1, wherein said storage and retrieval unit is displaced horizontally from one said shelf to another said shelf in a height position located at a spaced location from a shelf bottom on a horizontal path between the shelves (1, 1′).

5. A method in accordance with claim 4, wherein said horizontal path is displaced vertically.

6. A method in accordance with claim 1, wherein said storage and retrieval unit, which is vertically extensible, is brought into a compact, flat, withdrawn position before transfer.

7. A method in accordance with claim 1, wherein before transfer, said storage and retrieval unit is equipped with containers or trays, which are transferred together with said storage and retrieval unit and are introduced released after transferring said storage and retrieval unit in the other shelf unit.

8. A method in accordance with claim 1, wherein said storage and retrieval unit is equipped with containers or trays in another shelf unit after transfer, said containers or trays to be introduced being transported by means of separate conveying means and being taken over by said storage and retrieval unit for introduction into another shelf unit or released in another shelf unit only.

9. A storage and retrieval system for operating a shelf for carrying out the method in accordance with claim 1 comprising:
one or more shelves;
one or more storage and retrieval units for retrieving and introducing containers, trays or the like from or into one or more shelves;
a height area of one or more shelves having a plurality of shelf levels arranged one on top of another, said plurality of shelf levels operating as an independent shelf unit (I, II, III, IV) by means of at least one mechanically coupled and longitudinally adjustable storage and retrieval unit; and
a transferring device having at least one vertical elevator for transferring said storage and retrieval unit from one or more shelf units into one or more other shelf units of the same shelf or of another shelf.

10. A storage and retrieval system in accordance with claim 9, wherein said vertical elevator is arranged in an area of a longitudinal end of a shelf.

11. A storage and retrieval system in accordance with claim 9 wherein said vertical elevator has holding and fixing means for a storage and retrieval unit, the vertical elevator receiving said storage and retrieval unit and vertically displacing said storage and retrieval unit.

12. A storage and retrieval system in accordance with claim 10, wherein said vertical elevator and/or each longitudinal end of each said shelf unit facing the vertical elevator has locking means, for blocking a shelf unit in relation to the vertical elevator for safely receiving a storage and retrieval unit in the shelf unit when the vertical elevator is being operated in another height position.

13. A storage and retrieval system in accordance with claim 9, wherein said vertical elevator comprises an elevator cage for receiving a storage and retrieval unit, said cage being vertically displaced between at least two said shelf units arranged one on top of another and can be positioned at a level of the shelf units.

14. A storage and retrieval system in accordance with claim 9, further comprising at least another transport elevator provided for separate transport of containers or trays, said elevator being located at one longitudinal end of the shelf.

15. A storage and retrieval system in accordance with claim 9, wherein a horizontal path is provided;
for horizontally displacing said storage and retrieval unit between the shelves from one said shelf to another said shelf in a height position located at a spaced location from a shelf bottom or the horizontal path can be displaced horizontally together with the storage and retrieval unit.

16. A storage and retrieval system in accordance with claim 15, wherein said horizontal path is adjustable in height.

17. A storage and retrieval system in accordance with claim 9, wherein said storage and retrieval unit has a lower and/or upper longitudinal chassis displaceable along a shelf front in a nontilting manner in fixed horizontal rails in levels of said shelf units.

18. A storage and retrieval system in accordance with claim 17, wherein said storage and retrieval unit having a vertical mast with an upper and lower chassis wherein a height-adjustable load receiving means for containers or trays is provided along the vertical mast.

19. A storage and retrieval system in accordance with claim 18, wherein said vertical mast has an articulated joint permitting deflection of the mast in a direction of longitudinal displacement, the articulated joint being provided in an area of the upper chassis of the storage and retrieval unit.

20. A storage and retrieval system in accordance with claim 18 wherein said vertical mast extends over the height of a shelf unit.

21. A storage and retrieval system in accordance with claim 9, wherein said storage and retrieval unit, which is vertically extendable, is provided with a height-adjustable lifting table, said storage and retrieval unit being withdrawn into a compact, flat position before a transfer.
